(19) United States
(12) Patent Application Publication
(10) Pub. No.: US 2010/0082268 A1
(43) Pub. Date: Apr. 1, 2010

(54) METHOD AND APPARATUS FOR MONITORING A SWITCHING PROCESS AND RELAY MODULE

(76) Inventor: Peter Fischer, Schwandorf (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/559,819

(22) Filed: Sep. 15, 2009

(30) Foreign Application Priority Data
Sep. 26, 2008 (EP) PCT/EP2008/008359
Jun. 19, 2009 (EP) 09163275.2

(51) Int. Cl. G06F 19/00

(52) U.S. Cl. 702/34

(57) ABSTRACT

An apparatus for monitoring a switching process of a switching element for switching an electrical current for a consumer is provided. The apparatus includes a determination means for determining at least one individual consumption value of the consumer, a comparison means for comparing the at least one consumption value with a reference value, and a prediction means for predicting a maximum number of switching cycles as a function of the comparison result.

### CROSS REFERENCE TO RELATED APPLICATIONS

This application claims priority of International Application No. PCT/EP2008/008359 filed Sep. 26, 2008, and of European Patent Office Application No. 09163275.2 EP filed Jun. 19, 2009; all of the applications are incorporated by reference herein in their entirety.

### FIELD OF INVENTION

The invention relates to a method for monitoring a switching process of a switching element for switching an electrical current for a consumer.

The invention likewise relates to an apparatus for monitoring a switching process of a switching element for switching an electrical current for a consumer.

The invention also relates to a relay module with an apparatus for monitoring a switching process.

### BACKGROUND OF INVENTION

A relay module, preferably for use in a programmable controller, can switch a consumer connected to a switching output of the relay module by means of switching elements, preferably metallically configured contacts, but also switching elements embodied in particular using semiconductor technology. The connected consumer may be a signal lamp, a motor, a conveyor belt, a galvanic bath or high voltage system. When switching the said consumer, in particular in the case of consumers with a high power requirement, in particular start-up power requirement, the switching element and/or the metallic switching contacts are put under significant stress during the switching process. This stress results in subtle wear of the switching element. If the switching element is embodied as a metallic contact pair, the outer layer of the contacts will deteriorate over the course of time, for instance due to burning of the surface or as a result of corrosion. This means that if a maximum number of switching cycles is exceeded, this results in failure and/or damage to the contacts. From the point of view of a user, for instance within the field of automation technology, damage to a relay module means repair times and stoppage times for an electrical system, which is disadvantageous in terms of the production of goods for instance.

With relay modules according to the prior art, it is known to preset a defined maximum number of switching cycles, with the manufacturer generally guaranteeing a faultless function of the relay module with this presettable maximum number of switching cycles. This presettable maximum number of switching cycles is nevertheless an estimation. It may be that a switching element already becomes worn before reaching the maximum number of switching cycles or it may also be that a switching element can be operated in a fault-free fashion for far longer than the cited maximum number of switching cycles.

### SUMMARY OF INVENTION

It is an object of the present invention to specify a method which enables better information to be provided relating to the maximum possible number of switching cycles of a switching element.

The object is achieved by the method cited in the introduction in that at least one individual consumption value of the consumer is determined, the consumption value is compared with a reference value and a prediction for a maximum number of switching cycles is given as a function of a comparison result. It is advantageous here that the individual consumption values of the connected loads are taken into consideration, so that the assumption can be made for instance in the case of a connected motor that it supplies different individual consumption values in the case of a soft start-up than in the case of a start-up with a heavy load. The switching element is also put under varying stress as a function of this different operation. A service life of the mechanical contact for instance is dependent inter alia on: a voltage to be switched, for instance an alternating voltage or a direct current voltage, a level of voltage, a load to be switched on, such as an ohmic load, an inductive load or a capacitive load, a switch-on current and a switch-off current. Wear to the contact of the switching element is accordingly dependent on many variables and these variables have an important effect on the service life of the switching element. A prognosis relating to possible wear of the switching element can be determined more precisely by comparing the determined consumption values with reference values, which were recorded with defined current and voltage ratios.

It is expedient if a temporal progression of the current is determined. First information relating to its electrical state, such as for instance a preferentially inductive load or a preferentially capacitive load, can be provided on the basis of a characteristic curve progression of the current of a consumer.

It is also expedient here to determine a temporal progression of a voltage at the consumer. Knowledge of the temporal progression of the current and the voltage also allows the accuracy of information relating to the consumer to increase.

It is particularly advantageous here if the temporal progression of the current and/or the voltage is analyzed section by section and information relating to possible wear of the switching element is given.

The method is also optimized if characteristic data of the consumer is determined and stored. The method-related storage of the characteristic data corresponds to a “teach-in-function”, the method is thus suited to identifying and adjusting to modified preconditions during implementation.

In a further embodiment of the invention, the achievement of a presettable first number or the maximum number of switching cycles is monitored, and a warning is output when one of the two numbers is exceeded. Since different loads can be switched depending on the use of a switching apparatus, with which the method is used, a projection for the maximum number of switching cycles will change continuously as a function of use. If the last 100 switching processes were implemented with a high load for the switching element for instance, the prognosis will approach a “worst case” threshold for the maximum number of switching cycles. If however the last 100 switching processes were implemented virtually without a noteworthy load, the maximum number of switching cycles will move toward a “best case” value.

In order to avoid destroying the switching element or to avoid an unreliable switching connection, repeated switching is expediently prevented when one of the two numbers is exceeded.

In a preferred embodiment, a magnetoresistive sensor is used for the contactless measurement of the electrical current.

A micro-electro-mechanical measuring system is also preferably used to measure the voltage. A MEMS voltmeter is used in this method.

The apparatus cited in the introduction likewise achieves the object cited in the introduction in that the apparatus comprises a determination means for determining at least one individual consumption value of the consumer, a comparison means for comparing the at least one consumption value with a reference value and a prediction mean for predicting a maximum number of switching cycles as a function of the comparison result. Particularly in the case of safety switching devices, which have to ensure a functional reliability, for instance in accordance with the IEC 61508 standard, an apparatus of this type can be used with significant advantage. Users of relay modules within the field of safety engineering for instance previously had to focus on a B10 value. The B10 value corresponds to the switching cycles for devices which are affected by wear. With the apparatus it is now possible not to evaluate a maximum number of switching cycles statically but instead to be able to respond to the given conditions of use in an appropriate fashion. By way of example, the apparatus could also feed back to a higher-order control system and trigger a prompt warning that a switching element should be replaced.

The apparatus is configured in accordance with the features of the dependent claims, with the advantages already cited for the method substantially resulting.

A relay module with an apparatus for monitoring a switching process of a switching element for switching an electrical current for a consumer as claimed in the claims also achieves the object cited in the introduction.

### BRIEF DESCRIPTION OF THE DRAWINGS

Further advantages and features are described with reference to the drawing, in which:

FIG. 1 shows an exemplary embodiment of a relay module with an apparatus for monitoring a switching process,

FIG. 2 shows a schematic drawing to clarify the functionality of a micro-electro-mechanical system, MEMS voltmeter,

FIG. 3 shows a further schematic drawing to further illustrate the micro-electro-mechanical system and

FIG. 4 shows an exemplary embodiment of a micro-electro-mechanical system.

### DETAILED DESCRIPTION OF INVENTION

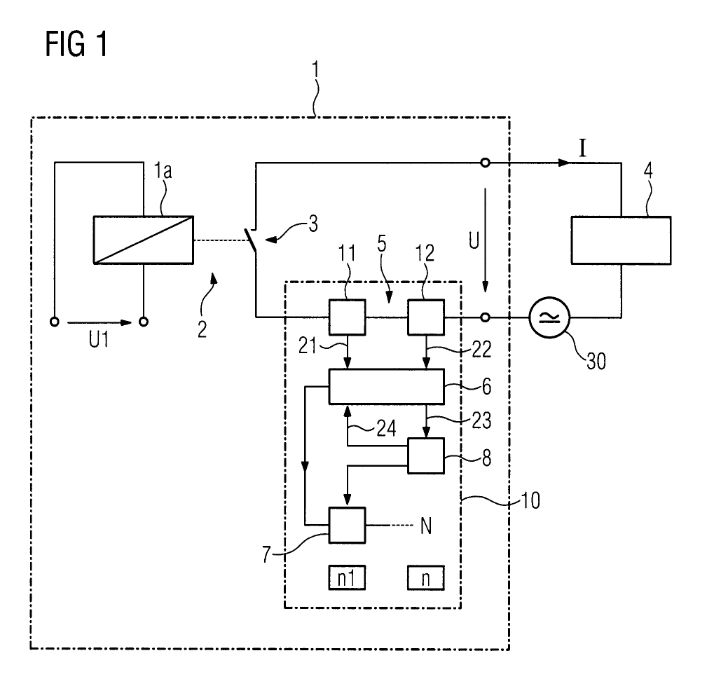

According to FIG. 1, a relay module 1 is shown, with the relay module 1 having an apparatus 10 for monitoring a switching process of a switching element 3 for switching an electrical current I for a consumer 4. The consumer 4 is connected to the relay module 1 by way of connecting terminals. A voltage source 30 is in the current circuit of the consumer 4, with the current circuit being closed by closing the switching element 3 and the voltage source 30 being able to drive a current I through the consumer 4. The voltage source 30 may be embodied as an alternating voltage source or as a direct current voltage source.

The switching element 3 is actuated by means of a relay coil 1a by way of an active connection. The relay coil 1a is excited by applying a switching voltage U1 to a first relay coil input and second relay coil input in order to switch the switching element 3. The relay coil 1a and the switching element 3 form a relay 2.

The apparatus 10 for monitoring the switching process of the switching element 3 has a determination means 5 for determining at least one individual consumption value of the consumer 4. The determination means 5 is embodied here as a magnetoresistive sensor 11 and as a micro-electro-mechanical system 12. MEMS voltmeter is also used below to mean micro-electro-mechanical system 12.

The magnetoresistive sensor 11 and the micro-electro-mechanical system 12 are arranged here on a conductor guiding the current I such that they can determine the consumption values of the consumer 4 in a contactless fashion. The sensor 11 is embodied here so as to determine the current I and the micro-electro-mechanical system 12 is designed to determine the voltage U.

To be able to provide a prediction for a maximum number of switching cycles N as a function of a comparison result, the apparatus 10 also has a comparison means 6, a prediction means 7 and a storage means 8. The comparison means 6 is connected to the sensor 11 and the micro-electro-mechanical system 12 such that the sensor 11 provides a first input variable 21 and the MEMS voltmeter 12 provides a second input variable 22 for the comparison means 6. The comparison means 6 is embodied here so as to determine the individual consumption values of the consumer 4 and to compare the consumption values with reference values, with the reference values being supplied to the comparison means 6 by way of an input 24 for reference values which is connected to the storage means 8.

The reference values in the storage means 8 can already be stored in the storage means 8 prior to commissioning the relay module 1 but it is however also possible to make the reference values available to the storage means 8 by way of an output for reference values of the comparison means 6. During operation of the relay module 1, the characteristic data of the consumer, 4 is detected here by means of the sensor 11 and the MEMS voltmeter 12 by way of the determination means 6 and is stored in the storage means 8. A learning function or “teach-in function” is thus realized with the apparatus 10.

The prediction means 7 preferably reads in the current characteristic temporal progressions of the current I and the voltage U during a switching process by way of a connection to the determination means 6 and uses the reference values and/or reference voltage and current profile stored in the storage means 8 when predicting a possible maximum number of switching cycles N. An absolute counter n is designed to continuously count each switching process. A presettable first number n1 of switching cycles is stored in a further storage means. The apparatus 10 can be configured such that a warning can be output if the presettable first number n1 or the maximum number of switching cycles N is achieved. It is also conceivable to configure the apparatus 10 such that a repeated switching of the switching element 3 is prevented when one of the two numbers N, n1 is exceeded.

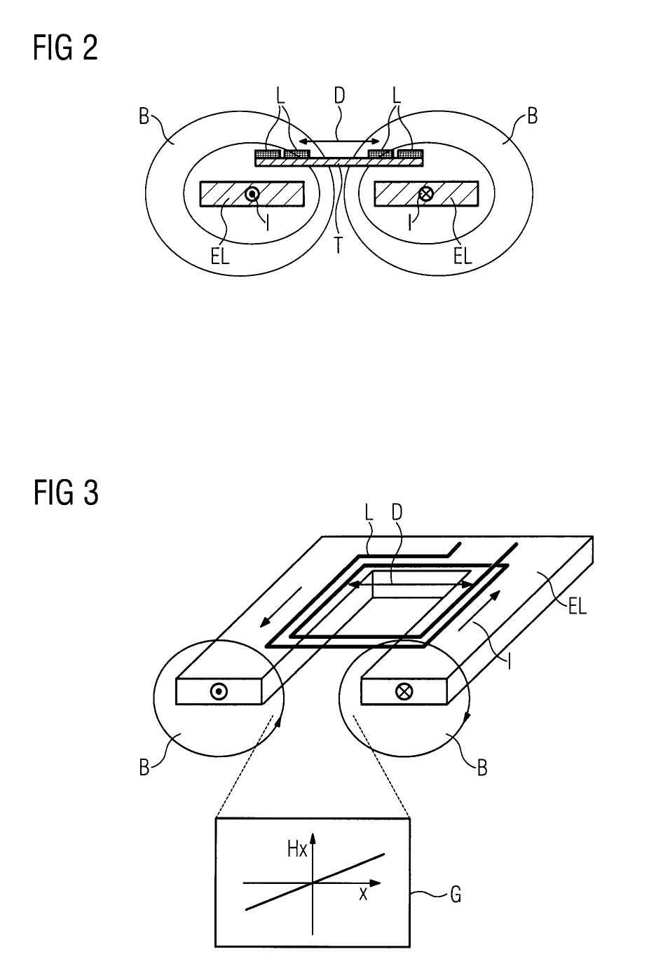

FIG. 2 shows a schematic drawing to clarify the functionality of a micro-electro-mechanical system, MEMS voltmeter.

A cross-section at right angles to the direction of an electrical conductor EL, consisting of a forward and return conductor, is shown. An electrical current I, the flow direction of which is indicated in the usual fashion, flows in the electrical conductor EL. A magnetic field B forms around the electrical conductor EL due to the current I flowing in the electrical conductor EL.

In order now to detect a measured variable for the current I flowing through the electrical conductor EL by means of a micro-electro-mechanical system and/or to be able to quantitatively measure this current I, a measuring coil L is provided which, in the exemplary embodiment shown, has two windings and is embodied to be flat. The measuring coil L is attached to a support T, which is moved by means of a micro-mechanical and/or micro-electro-mechanical oscillator (not shown for reasons of clarity) such that a cyclical change is brought about in the magnetic flux through the measuring coil L. In the exemplary embodiment described, the micro-electro-mechanical oscillator and thus also the measuring coil L connected to the support T is oscillated here in the movement direction D indicated by the double arrow, i.e. at right angles to the course of the electrical conductor EL. Due to the change in the magnetic flux through the measuring coil L which is brought about by the movement of the measuring coil L in the magnetic field B of the electrical conductor EL, a voltage is induced in the measuring coil L, which is proportional to the electrical current I flowing through the electrical conductor EL and thus represents a measured variable for the same.

It should be noted that, contrary to the illustration in FIG. 1, the measuring coil L could naturally also be moved in a magnetic field of an individual electrical conductor, i.e. not between a forward and return conductor. Based on the illustration in FIG. 1, this could for instance be such that the left part of the electrical conductor EL is left out of the illustration and the support T with the measuring coil L is moved to the right so that the measuring coil L oscillates around the centre of the electrical conductor EL then only comprising one conductor. In this instance too there is change in the magnetic flux through the measuring coil L so that a measured variable for the current I flowing through the electrical conductor EL can also be detected by means of such an arrangement. The embodiment shown in FIG. 1 is nevertheless advantageous in that because the measuring coil L is moved between the forward and return conductors of the electrical conductor EL, the voltage induced in the measuring coil L has a greater amplitude. This is because a particularly marked change in the magnetic flux through the measuring coil is brought about by the movement of the measuring coil L between the forward and return conductor.

To achieve as great an induced voltage as possible and/or to be able to increase the insulation distance between the measuring coil L and the electrical conductor EL if necessary, it is also possible to increase the number of windings and/or the surface of the measuring coil L and/or to select the amplitude of the movement brought about by the micro-electro-mechanical oscillator to be as great as possible.

In respect of its dimensioning, the arrangement shown in FIG. 2 could be configured for instance such that with an electrical conductor EL with a width of 2 mm, the distance between the measuring coil L and the surface of the electrical conductor EL amounts to half a millimeter. Accordingly, the measuring coil L in the illustration in FIG. 2 could have a horizontal extension in the region of 1 mm and the amplitude of the cyclical movement brought about by the micro-electro-mechanical oscillator could amount to half a millimeter for instance. It should however be pointed out clearly that the said values are only examples and arrangements with clearly deviating values are also conceivable as a function of the respective requirements and the respective intended use.

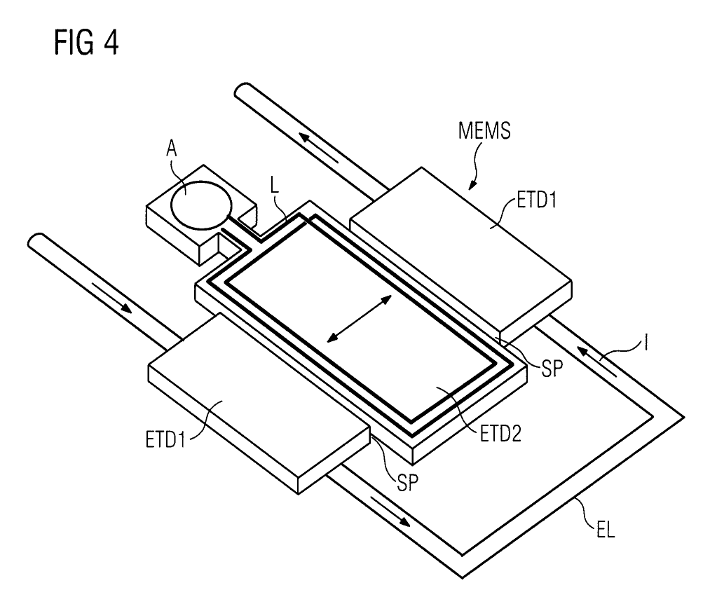

FIG. 3 shows a further schematic drawing for further clarifying the micro-electro-mechanical system. A perspective illustration of an arrangement essentially corresponding to FIG. 2 is shown here, with the support of the measuring coil L having been left out for improved clarity. It is apparent that the measuring coil L is moved between a forward and return conductor in the form of the arms of a U-shaped electrical conductor EL, with the direction of movement D being indicated again by a corresponding arrow. The component of the magnetic field B which results in the case of a current I flowing through the electrical conductor EL and the magnetic field caused by this current I in the direction of movement D is referred to as Hx and shown as a function of the position x in the direction of movement D in the graph G. It is apparent that the magnetic field Hx changes in the direction of movement D so that in the case of a movement of the measuring coil L in the direction of movement D, a change in the magnetic flux through the measuring coil L results. A voltage is induced here in the measuring coil L, which represents a measured variable for the current I flowing through the electrical conductor EL.

To achieve as large a signal amplitude of the induced voltage as possible, the oscillation frequency of the micro-electro-mechanical oscillator is preferably selected within the region of a few kilohertz up to the megahertz region. It should be pointed out here that the oscillation frequency of the micro-electro-mechanical oscillator is preferably selected such that the spectral components of the electrical current I in the range of the operating frequency of the micro-electro-mechanical oscillator can be disregarded. To this end, band pass filtering with a minimal bandwidth is advantageously provided and the operating frequency of the micro-electro-mechanical oscillator is selected to be considerably greater, i.e. for instance greater by a factor 10 to 100, than the maximum frequencies occurring in the spectrum of the electrical current I with significant amplitude. This means that if no direct current is to be detected but instead an electrical alternating current with a frequency of 1 kHz for instance, a micro-electro-mechanical oscillator is preferably used for this purpose, the operating frequency thereof lies in the region of at least 10 kHz.

FIG. 4 shows an exemplary embodiment of a micro-electro-mechanical system as a measuring device. A micro-electro-mechanical system MEMS, which comprises an armature A, a measuring coil L, two first electrodes ETD1 and a second electrode ETD2, is shown. In addition to the micro-electro-mechanical system MEMS, a U-shaped electrical conductor EL is also shown in the arrangement shown in FIG. 3. It should generally be noted here that the electrical conductor EL can basically also be an integral part of the actual measuring apparatus. In this case, a current to be measured is thus introduced into the electrical conductor EL, which, in this case, will usually be arranged in the measuring apparatus at a fixed distance from the micro-electro-mechanical system MEMS. Alternatively, the electrical conductor EL can however also be an integral part of any other component, in which case the actual measuring apparatus therefore does not include the electrical conductor EL.

With the micro-electro-mechanical system MEMS shown in FIG. 4, a micro-electro-mechanical oscillator is formed by the armature A and the first electrode ETD1 and the second electrode ETD2. The part of the oscillator which is able to oscillate, which is provided by the second electrode ETD2, is suspended from the armature A. An air gap SP, the width of which usually lies within the millimeter range, is located between the second electrode ETD2 and the respective first electrode ETD1 in each instance. By cyclically applying corresponding potentials to the electrodes ETD1, ETD2, a mechanical oscillation of the second electrode is brought about due to active electro-static forces, with the movement direction in FIG. 4 being indicated by the double arrow shown. According to the illustration, a measuring coil L, which again has two windings in the illustrated example, is fastened to the second electrode ETD2, so that the measuring coil L is moved by means of the micro-electro-mechanical oscillator such that a cyclical change in the magnetic flux through the measuring coil L is brought about as a result of the movement of the measuring coil L in the magnetic field of the electrical conductor EL brought about by the electrical current I. As explained previously, a voltage is thus induced in the measuring coil L, which can be detected by corresponding means and can be determined from the current I flowing in the electrical conductor EL.

It should be pointed out here that it is naturally also possible within the scope of the inventive micro-electro-mechanical system to use micro-electro-mechanical oscillators, which operate according a principal other than an electro-static principle. Care is also taken to point out that a measuring coil can naturally also be used with just one or even more than two windings.

The micro-electro-mechanical system shown in FIG. 4 can also preferably comprise a capacitative voltage meter for detecting the voltage of the electrical conductor EL. A corresponding micro-electro-mechanical system for capacitive voltage measurement is known for instance from the previously mentioned WO 2005/121819 A1. The voltage meter is preferably coupled here to the micro-electro-mechanical oscillator so that the movement brought about by the oscillator not only brings about the change in the magnetic flux through the measuring coil but also brings about a capacity change which is needed within the scope of the voltage measurement. A micro-electro-mechanical system for power measurement, i.e. a watt meter, is advantageously provided here in a particularly simple, compact and cost-effective fashion.

According to the afore-described exemplary embodiments, the inventive micro-electro mechanical system as well as the inventive method are particularly advantageous in that a galvanically isolated as well as multi-functional detection of a measured variable for the current flowing through the electrical conductor is enabled in a comparatively simple manner. In particular because the electrical current, which is to be measured and flows through the electrical conductor, does not itself need to flow through the micro-electro-mechanical system here, the micro-electro-mechanical system and the method are also advantageously particularly efficient especially in respect of the fact that they can be used with comparatively high current strengths.

All the effects which describe the change in the electrical resistance of a material by applying an external magnetic field are referred to as magnetoresistive effects. These include in particular the anisotropic magnetoresistive effect (AMR effect), the “gigantic” magnetoresistive effect (GMR effect), the CMR effect, the TMR effect and the planar Hall effect.

1-16. (canceled)

17. A method for monitoring a switching process of a switching element for switching an electrical current for a consumer, comprising:
determining an individual consumption value of the consumer;
comparing the individual consumption value with a reference value; and
providing a prediction for a maximum number of switching cycles as a function of a comparison result.

18. The method as claimed in claim 17, wherein a temporal progression of the current is determined.

19. The method as claimed in claim 17, wherein a temporal progression of a voltage is determined at the consumer.

20. The method as claimed in claim 18, wherein the temporal progression of the current is analyzed section by section, and wherein information relating to a possible wear of the switching element is provided.

21. The method as claimed in claim 19, wherein the temporal progression of the voltage is analyzed section by section, and wherein information relating to a possible wear of the switching element is provided.

22. The method as claimed in claim 19, wherein the temporal progression of the current and the voltage is analyzed section by section, and wherein information relating to a possible wear of the switching element is provided.

23. The method as claimed in claim 17, further comprising:
determining and storing characteristic data of the consumer.

24. The method as claimed in claim 17, further comprising:
monitoring the achievement of a presettable first number or the maximum number of switching cycles; and
outputting a warning when one of the two numbers is exceeded.

25. The method as claimed in claim 24, wherein a repeated switching is prevented when one of the two numbers is exceeded.

26. The method as claimed in claim 17, wherein a magnetoresistive sensor is used for a contactless measurement of the electrical current.

27. The method as claimed in claim 19, wherein the voltage is measured in a contactless fashion with a micro-electro-mechanical system.

28. An apparatus for monitoring a switching process of a switching element for switching an electrical current for a consumer, comprising:
a determination means for determining an individual consumption value of the consumer;
a comparison means for comparing the consumption value with a reference value; and
a prediction means for predicting a maximum number of switching cycles as a function of a comparison result.

29. The apparatus as claimed in claim 28, wherein the determination means is configured to determine a temporal progression of the current.

30. The apparatus as claimed in claim 28, wherein the determination means is configured to determine a temporal progression of a voltage at the consumer.

31. The apparatus as claimed in claim 28, further comprising:
a storage means for storing characteristic data of the consumer.

32. The apparatus as claimed in claim 30, further comprising:
a magnetoresistive sensor for measuring the voltage.

33. The apparatus as claimed in claim 30, further comprising:
a micro-electro-mechanical system for measuring the voltage.

34. A relay module, comprising:
an apparatus for monitoring a switching process of a switching element for switching an electrical current for a consumer, the apparatus comprising:
a determination means for determining an individual consumption value of the consumer;
a comparison means for comparing the consumption value with a reference value; and
a prediction means for predicting a maximum number of switching cycles as a function of a comparison result.

35. The relay module as claimed in claim 34, wherein the determination means of the apparatus is configured to determine a temporal progression of the current.

36. The relay module as claimed in claim 34, wherein the determination means of the apparatus is configured to determine a temporal progression of a voltage at the consumer.
